(19) United States
(12) Patent Application Publication
(10) Pub. No.: US 2025/0111389 A1
(43) Pub. Date: Apr. 3, 2025

(54) SALES DATA COLLECTION TOOL

(71) Applicant: ProspectStream Software, Inc., Mason, OH (US)

(72) Inventor: Stephen R. Farfsing, Cincinnati, OH (US)

(21) Appl. No.: 18/904,848

(22) Filed: Oct. 2, 2024

Related U.S. Application Data
(60) Provisional application No. 63/542,031, filed on Oct. 2, 2023.

(51) Int. Cl. G06Q 30/0201

(52) U.S. Cl. CPC G06Q 30/0201

(57) ABSTRACT

Methods and systems are described for optimizing CRM (customer relationship manager) systems and sales outcomes. A daily prioritized task or call list can be presented to a salesperson. The daily list can provide a salesperson with an optimized procedure or order of tasks for the day without the salesperson having to access a CRM and determine their own tasks for the day, saving valuable time. The daily list can be prioritized on various factors, such as preferred number of days between calls, times of day depending on time zones or other unique factors for each potential sales target. A machine learning model can be used to optimize sales tactics.

### CROSS REFERENCE TO RELATED INFORMATION

This application claims the benefit of United States of America priority application No. 63/542,031 filed on Oct. 2, 2023, titled “Sales Data Collection Tool,” the contents of which are hereby incorporated in their entirety.

### TECHNICAL FIELD

The present disclosure generally relates to the technical field of machine learning.

### BACKGROUND

There exist a variety of customer relationship management (CRM) tools that track customer data. CRM solutions are often online spreadsheets. Tracked data includes customer address, name, contact information and other factors. CRM tools can track highly valuable information-customer lists can be some of a company's most valuable trade secrets. Data entry in CRM tools is often by users entering free text, inputting any information they desire or think might be valuable.

### SUMMARY

One embodiment under the present disclosure comprises a system for CRM. The system comprises a conversation recorder configured to record one or more conversations between a salesperson and one or more sales targets; and a user interface coupled to the conversation recorder and configured to receive input from the salesperson. It further comprises one or more servers coupled to the user interface and configured to store one or more data points related to the one or more sales targets, wherein the one or more data points includes the one or more conversations and wherein the one or more servers are further configured to provide the salesperson, via the user interface, a task list for a specific work day, the task list comprising a prioritized list of the one or more sales targets, the prioritized list comprising an optimized order of the one or more sales targets to maximize one or more sales campaigns, wherein the prioritized list is based at least in part on the one or more data points.

Another embodiment under the present disclosure is a method performed by a CRM system for prioritizing one or more sales targets. The method includes (a) storing one or more data points related to one or more sales targets, the one or more data points comprising one or more communications between a salesperson and the one or more sales targets; (b) creating a prioritized list of the one or more sales targets, the prioritized list comprising an optimized order of the one or more sales targets to maximize one or more sales campaigns, wherein the prioritized list is based at least in part on the one or more data points; and (c) displaying the prioritized list to a salesperson. It further includes (d) detecting an indication to begin the prioritized list from the salesperson; (e) presenting to the salesperson information related to a first of the one or more sales targets on the prioritized list, the information comprising an option to call the first of the one or more sales targets; and (f) receiving a command to initiate a call to the first of the one or more sales targets. It further comprises (g) initiating the call; (h) recording the call; (i) presenting one or more mandatory questions to the salesperson after the call has ended; and (j) preceding to a subsequent one of the one or more sales targets on the prioritized list only when the one or more mandatory questions are completed. It further comprises (k) updating the one or more data points with the recording of the call and one or more answers to the one or more mandatory questions; and (l) repeating steps (f) to (k) for each subsequent one of the one or more sales targets on the prioritized list.

Another embodiment can comprise a system for CRM. The system comprises a computing device configured to transmit information to a user and to receive commands from the user; a microphone coupled to the computing device and configured to record one or more phone conversations of the user with one or more sales targets; and a customer database coupled to the computing device and configured to store one or more data points related to the one or more sales targets, the one or more data points comprising the one or more phone conversations. The system further comprises a task list module coupled to the computing device and the customer database and configured to apply one or more preference rules to the one or more sales targets to create a daily prioritized list, the daily prioritized list comprising an optimized order of the one or more sales targets to maximize one or more sales measurements, wherein the prioritized list is based at least in part on the one or more data points and the one or more preference rules, the task list module further configured to transmit the daily prioritized list to the computing device for display to the user, wherein when displayed to the user the daily prioritized list allows the user to initiate the one or more phone conversations in the order of the daily prioritized list, wherein the daily prioritized list requires the user to answer one or more questions about the one or more phone conversations to proceed to a subsequent one of the one or more sales targets, the task list module further configured to update the one or more data points with the one or more phone conversations and answers to the one or more questions. The system further includes a machine learning module coupled to the task list module and the customer database and configured to apply a machine learning model to the one or more data points and to adjust the prioritized list to maximize one or more sales measurements based on the analysis, the machine learning module further configured to update the machine learning model with the updated one or more data points.

Another possible embodiment under the present disclosure is a computer implemented method for training a machine learning model for optimizing one or more sales outcomes. The method comprises obtaining a dataset of identified sales tactics; training the ML model using the dataset of identified sales tactics thereby obtaining a trained ML model, and storing the trained ML model.

A further possible embodiment under the present disclosure comprises a computer implemented method for obtaining optimized sales tactics. The method includes inputting a dataset of sales tactics into a trained model, the model being trained using one or more recordings of one or more sales calls between one or more salespeople and one or more sales targets, one or more answered questions required of the one or more salespeople after each of the one or more sales calls, and one or more sales outcomes related to the one or more sales targets; and obtaining a dataset of sales tactics labeled by the trained model.

This summary is provided to introduce a selection of concepts in a simplified form that are further described below in the detailed description. This summary is not intended to identify key features or essential features of the claimed subject matter, nor is it intended to be used as an indication of the scope of the claimed subject matter.

### BRIEF DESCRIPTION OF THE DRAWINGS

For a more complete understanding of the present disclosure, reference is now made to the following descriptions taken in conjunction with the accompanying drawings, in which:

FIG. 1 illustrates an embodiment of a CRM system and sales data collection system under the present disclosure;

FIG. 2 illustrates an embodiment of a prioritized task list under the current disclosure;

FIG. 3 illustrates an embodiment of a customer list under the present disclosure;

FIG. 4 illustrates an embodiment of a customer information screen under the present disclosure;

FIG. 5 illustrates an embodiment of sales call scripts and prompts under the present disclosure;

FIG. 6 illustrates an embodiment of a post call question under the present disclosure;

FIG. 7 illustrates an embodiment of a post call question under the present disclosure;

FIG. 8 illustrates an embodiment of a post call question under the present disclosure;

FIG. 9 illustrates an embodiment of a post call question under the present disclosure;

FIG. 10 illustrates an embodiment of a post call question under the present disclosure;

FIG. 11 illustrates another embodiment of a customer information screen under the present disclosure;

FIG. 12 shows a schematic of a CRM system embodiment under the present disclosure;

FIG. 13 shows a flow-chart of machine learning training and inference pipelines embodiments under the present disclosure;

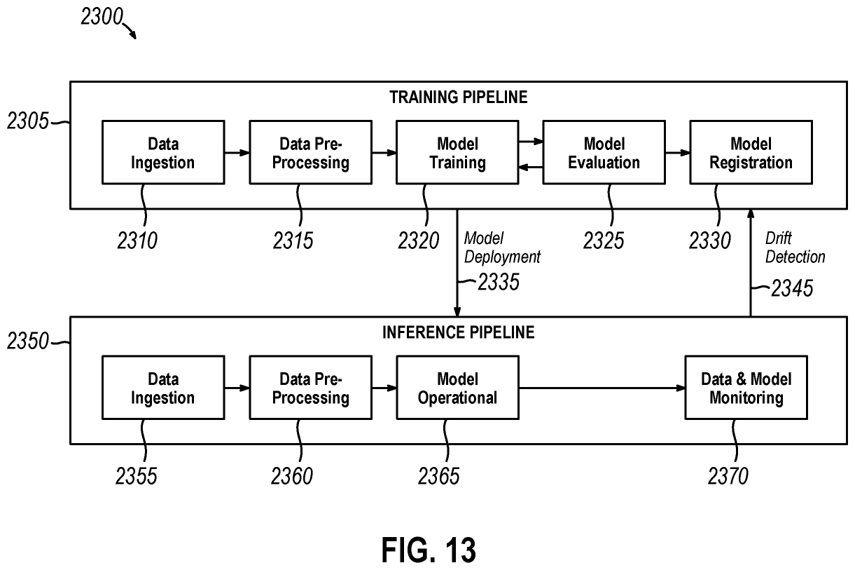

FIG. 14 shows a schematic of a neural network embodiment under the present disclosure;

FIG. 15 shows a flow-chart of a method embodiment under the present disclosure;

FIG. 16 shows a flow-chart of a method embodiment under the present disclosure;

FIG. 17 shows a flow-chart of a method embodiment under the present disclosure; and

FIG. 18 shows an embodiment of a sales campaign user interface under the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed embodiments. In addition, the terminology used herein is for the purpose of describing the embodiments and is not necessarily intended to limit the scope of the claimed embodiments.

There currently exist certain challenges to the statistical analysis, integration of computer systems and phones used by salespeople, and tracking of data related to sales pitches and techniques. Collecting and analyzing sales data can be difficult. Numbers of items sold might be tracked. But data around sales calls, sales pitches, metrics of performance for salesman, and other aspects preceding a sales event can be hard to track and analyze. There exist a variety of customer relationship management (CRM) tools, but these typically rely on salespeople to enter data. Data such as customer address or contact information is typically accurate and easy to analyze. But customer trends, impact of different sales approaches and similar factors and variables are hard to track in standard CRM tools. Salespeople do not all enter data the same way. And important data is not standardized to an analyzable format. User errors are rampant. CRM systems also do not integrate directly with phones, smartphones, tablets and other devices in ways that can maximize data collection and analysis.

Certain aspects of the embodiments disclosed herein provide solutions to these or other challenges. Embodiments include a sales data collection, scheduling, and analysis tool. Embodiments can integrate together a phone, smartphone, tablet, CRM system and desktop or mobile application for data collection and tracking related to sales pitches and customer data. Machine learning can also be integrated so as to provide enhanced sales analysis and provide guidance to improve sales outcomes. Certain embodiments can involve tracking and recording of all communications with a (potential) customer, whether by email, text, phone, video conference, or otherwise, and extracting data from these communications. Another aspect of certain embodiments is providing users a (e.g., mobile) application for interacting with e.g., recorded conversations and a history of communications with a potential customer, and requiring certain data entry. This standardized, and mandated data entry, allows for greater manipulation by machine learning techniques and other data mining activities. Embodiments can track a sales experience (e.g., all calls, emails, in person, or other communications with a potential customer, as well as obtained customer data, such as location, industry, company size, time zone, weather at location, or other variables) and mandate certain behaviors by a salesperson, such as mandating a follow up call by a certain date, or a follow up email of a determined format). Embodiments can also create and prioritize a daily schedule for a salesperson. For example, through tracking e.g., 500 different sales experiences, the system can determine a task list for a given day.

Certain embodiments may provide one or more of the following technical advantages. Maybe the biggest drain on a salesperson's time is planning a schedule and determining appropriate next steps in a sales experience. For example, a salesperson may take a third of a day just to decide and strategize what to do on that specific day. This process can require in depth analysis of various records in a CRM system, reviewing of various notes from calls or emails and time wasted on planning-instead of spending that time on selling. Embodiments described herein can save time by streamlining many functions that take up a salesperson's day. Other features can include automatically determining forecasted or current weather at a customer's location, automatically scheduling calls based on a customer's location and time zone, or downloading publicly accessible information about a potential customer (e.g., company information on LinkedIn™ or Wikipedia™). It should be noted that references in the description to a customer can refer to a potential customer, an individual, a company, or any type of sales target.

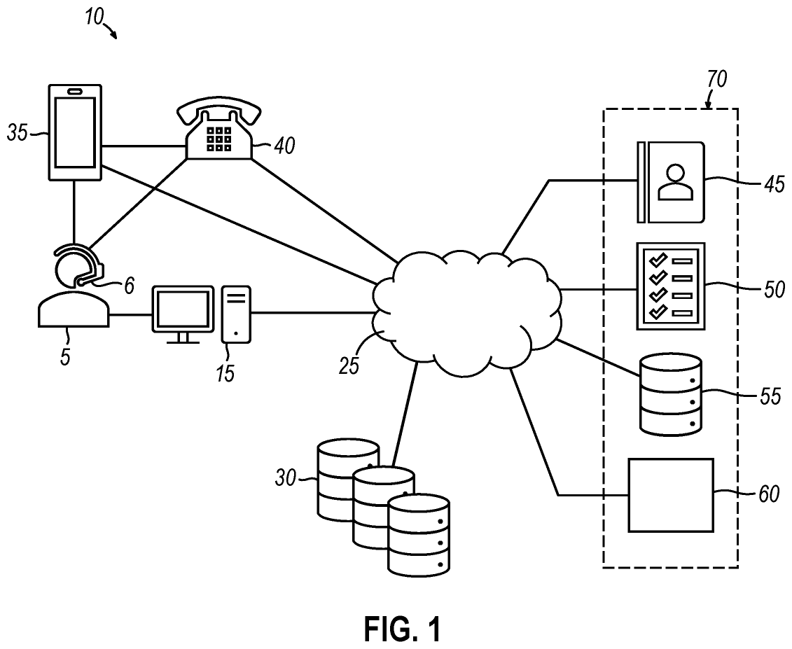

FIG. 1 illustrates one possible system embodiment 10 (e.g., a CRM system) under the present disclosure. A salesperson 5 may access system 10 via a computer 15, smart device (e.g., smartphone or tablet) 35, telephone 40, or other types of computing or communication devices (e.g., fax machine). A microphone 6 may also be used by salesperson 5. Any of smart device 35, telephone 40, computer 15, or microphone 6 may be able to place and/or record phone calls or other types of meetings. A conversation recorder, operable to record at least some of a salesperson's conversations, and preferably all conversations with sales targets, can comprise, for example, any of smart device 35, telephone 40, computer 15, or microphone 6. Cloud or internet 25 may allow these devices access to backend server(s) 70, which may comprise e.g., customer lists 45, task lists 50, databases 55, and artificial intelligence or machine learning (AI/ML) engine 60. Customer lists 45, task lists 50, databases 55, and AI/ML engine 60 may comprise a single server or set of servers and/or databases, or may be remotely coupled to each other. Cloud or internet 25 may allow access to a variety of websites 30, which may comprise websites, third-party databases, or other information sources or repositories.

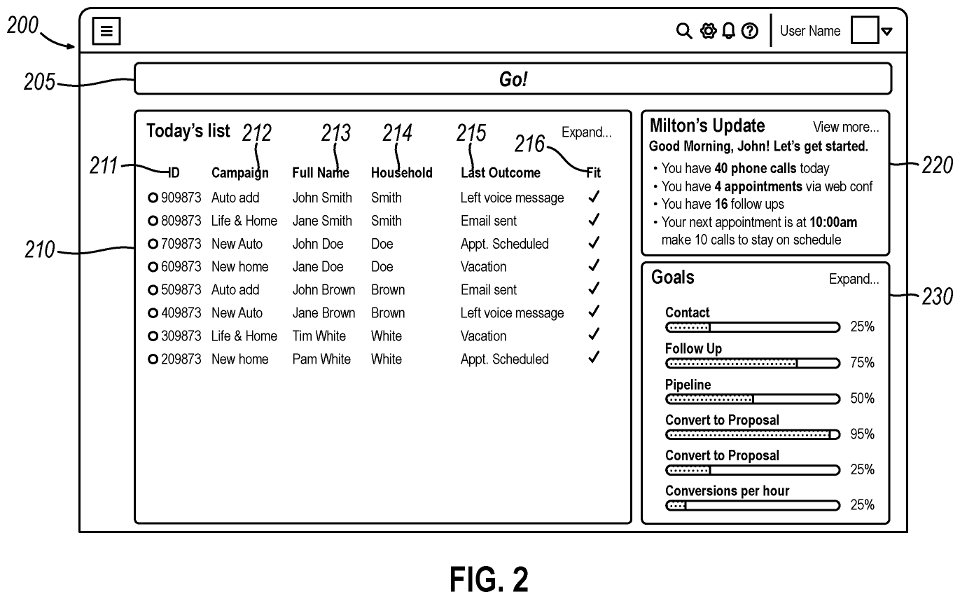

When a user logs in to computer 15 or smart device 35 at the beginning of his workday, he may see a screen such as home screen 200 shown in FIG. 2. Task list 210 (which may match task list 50 of FIG. 1) may provide an overview of tasks to complete during this specific workday. Each line of list 210 may comprise information about a potential/actual customer. Information can include identification number 211, campaign (e.g., name of a product or sales campaign) 212, full name 213, household name 214, last outcome 215, and fit 216. Updates/overview 220 may provide an overview of the salesperson's day, listing things like total calls scheduled, number of meetings, or other information. Goals 230 may provide an overview of sales totals for a year, a specific campaign, number/percentage of total calls made, or other goals or progress made toward goals. A go/start button 205 may pull up the first item in list 210 for the salesperson to begin their list of tasks.

One aspect of embodiments under the present disclosure is that list 210 is predetermined by an algorithm or machine learning system. Another aspect in certain embodiments, is that as a salesperson works through task list 210, closing one task to get to the next task may not be possible until all required information is filled out (or detected/determined automatically by the system).

System 10 of FIG. 1 is preferably used to track and record all interactions with customers and potential customers. As a result, when list 210 is provided to a user, the system 10 may know that potential customer A, for example, has received two previous phone calls (one resulting in a voice mail and the other resulting in a five minute discussion in which potential customer A expressed mild interest in a given product/service being sold); has received 10 marketing emails and clicked on two of them; manages purchasing for Company AA; offices in New York, NY; and is a female aged 55. Potential customer B, for example, has had three previous phone calls with the salesperson in which purchase size was discussed; has a net worth of $2 million; has a birthday in February; and lives in Dallas, TX. Various other factors, characteristics, locations, time zones, and other factors or variables can be tracked. When creating list 210 the system may access, for example, a website 30 of FIG. 1 to determine real time weather information or other conditions at a location of the potential customer, publicly available information about a company, or other information. Tracked information in, for example, customer list 45 or database 55, may include, for example, indications that a customer is only available in the afternoons, birthdays, hobbies or other interests of (potential) customers, preferences for text instead of email, or other information.

The construction of task list 210 of FIG. 2 or 50 of FIG. 1 can be based on a variety of rules, measurements, predictions, or other variables. For example, (potential) customers with a higher possible sale prediction can be prioritized. These predictions can be based on various factors of a person, a company, or a person's employer, or other variables, for example, a person's net worth, credit rating, number of employees, market capitalization, stock price, business type, business model, family size, house location, house value, type of car, age, business location, number of locations, or other factors.

The order of task list 210 can also take into account the location of a recipient/customer. A customer may be based several time zones away, or in another continent. The system can automatically detect that fact and schedule an optimum time to call that person. The system may also perform tasks such as checking weather forecasts and information at a customer location, such as by contacting websites 30 or other outside information sources. The system may know, or learn (as discussed further below), that sales are more likely in good weather. As a result, the weather at a customer location may affect or determine when during the day the task list 210 tells the salesperson to call that customer. The system may also search the Internet for information about a sales target. This could even allow the system to develop a personality profile of a sales target. The system also preferably has personality profiles of all salespeople and can match salespeople and sales targets with similar or beneficial personality profiles. Aspects of the personality profile can included gender, age, mode dress in social media postings, language used in social media postings, or other information. It can also take advantage of specially designed questions asked by the salesman to add weight to the profile assessment.

In certain embodiments the task list 210 activates the right task at the right time (through preset rules or algorithms, or via improved ML-based rules that are improved through iteration, described further below) and records the result in the form of an outcome (disposition). Task list 210 can be unique for different salespeople and with a different set of tasks, campaigns, and outcomes for a sales manager overseeing multiple salespeople. For example, for a manager there could be a campaign for managing the tasks associated with a sequence of training activities. The sequence of training activities can be managed from the campaign. AI/ML can identify which of the salespeople need that training based on their performance or from a schedule of preplanned training modules. In certain embodiments, objectives of task list 210 include initiating a new task for a specific prospect (sales) or subject (any number of non-sales activities), showing appropriate history, initiating communication mode, guiding a salesperson(s) through the task or communication, and then recording the outcome. Objectives can also include, as the task is being worked, recording some data automatically (e.g., phone calls, video conferences, others) and providing, for the user, guidance to complete the task and collect any additional data.

A salesperson may be involved in multiple different campaigns: e.g., products A, B, and C. Product A may be prioritized (for any of a variety of reasons) over B and C. the system may therefore prioritize (potential) customers of Product A.

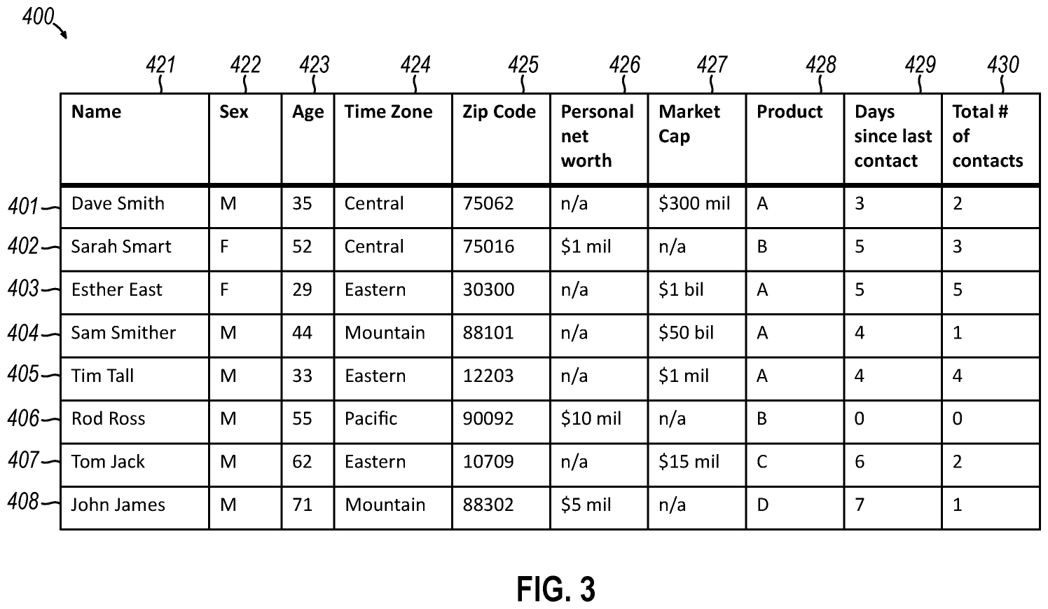

FIG. 3 illustrates a potential customer list 400 with customers 401-408. These customers 401-408 are just examples, there could be any number of customers or potential customers. Each customer 401-408 has data entries 421-430. There could be any number of data entries 421-430, even into the hundreds or thousands of data points that can be used to analyze a customer or potential customer, and prioritize and create a task list for each day. Customer 401 is a male, age 35, living in 75062, unknown or not applicable net worth, whose company has a market capitalization of $300 million, who was last contacted three days ago and who has had two total contacts (e.g., by phone, email or text). Customer 401 is a candidate for Product A (e.g., an insurance policy, a software package, or other product or service). The presence of market capitalization data 427 may indicate that customer 401 is a purchasing representative for their company, and product A is not intended for customer 401 as a personal product. Another example, customer 406, is a male aged 55, living in 90092, net worth of $10 million, unknown market cap, and a potential customer for product B. Product B may be something intended for individuals instead of an enterprise-type product. This may be why customer 406 net worth 426 is tracked instead of market cap 427. Customer list 400 may be stored in, or comprise, customer list 45 of FIG. 1.

Creating a task list 210 of FIG. 2 or 50 of FIG. 1 can comprise the use of numerous rules when applied to Customer list 400. For example, products C and D may be prioritized over products A and B. Because customer 408 has had more days since last contact, customer 408 may be prioritized over customer 407. After customer 407, 408, the other customers 401-406 may be under products A and B, which may be equally weighted. Other factors such as time zone 424, days since last contact 429, and net worth 426 or market cap 427 may be weighted differently. The system may first consider time zone 424, so as not to call, for example, Mountain and Pacific time zones too early in the day. Customers 403 and 405, both in Eastern time zone, may be scheduled first in the day, with customer 403 first because their company market cap 427 is larger than customer 405. Customers 401, 402 may come afterward due to being in the Central time zone. The system may prioritize customer 402 over 401 due to 402 having more days since last contact 429. In some variations, customer 401 could be excluded for a day, for example, if it is determined that four days is the preferred number of days to wait between calls or other forms of contact. Finally, customers 404 and 406 may come last. Customer 404 may be set before 406 due to being Mountain time versus Pacific. In some situations, the fact that customer 406 has never been contacted before may cause them to be prioritized over customer 404, if that factor is weighted more than time zone, for example. As a result, with this preceding example, the order of a task list may be as follows: 408-407-403-405-402-401-406-404. Other embodiments may leverage different rules, leading to a different order for the task list.

It should be noted that the task list may be dynamically sorted. For example, a meeting could come up that the salesperson should not miss, and the meeting may go long. Once the meeting is over, the system may detect that it is too late in the day to call customer 403 because that customer is in the Eastern time zone (e.g., after 1 pm, 3 pm, 5 pm, etc., depending on a setting or a detected preference of customer 403). As a result of the meeting going long, and a preference or setting regarding time for customer 403, a call or email to customer 403 may be dynamically rescheduled to the following day. A variety of factors could lead to an interruption to the task list, and the task list can be dynamically resorted accordingly.

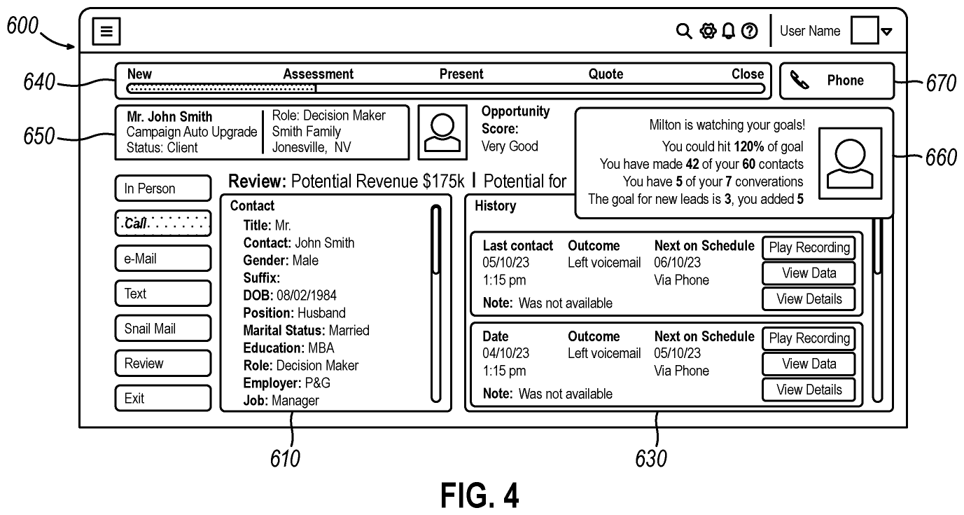

To begin work on their task list 210, a user may click the go button 205 and begin their daily tasks. A screen such as screen 600 of FIG. 4 can appear to help guide a salesperson through a call or other communication with a customer. Goal progress indicator 640 can display progress towards a complete sale to the customer. Information bar 650 may display basic information of a customer, such as name and potential value or likelihood of success. Virtual assistant 660 can prod the salesperson to fill out certain forms, perform certain tasks, or otherwise convey information to a user. Phone button 670 (text/email/etc. in other embodiments) may allow a user to initiate a phone call or other communication. Contact card 610 can provide basic information about a customer, such as birthday, age, martial status, employer, etc. Contact history 630 provides a list of previous communications with the customer, including, for example, recordings or transcriptions of phone calls, email history with all emails reproduced, text message history. Each item in the contact list can provide details about the communication, such as a result or topics discussed. Transcripts or recordings can be accessed and reviewed in the contact history list 630.

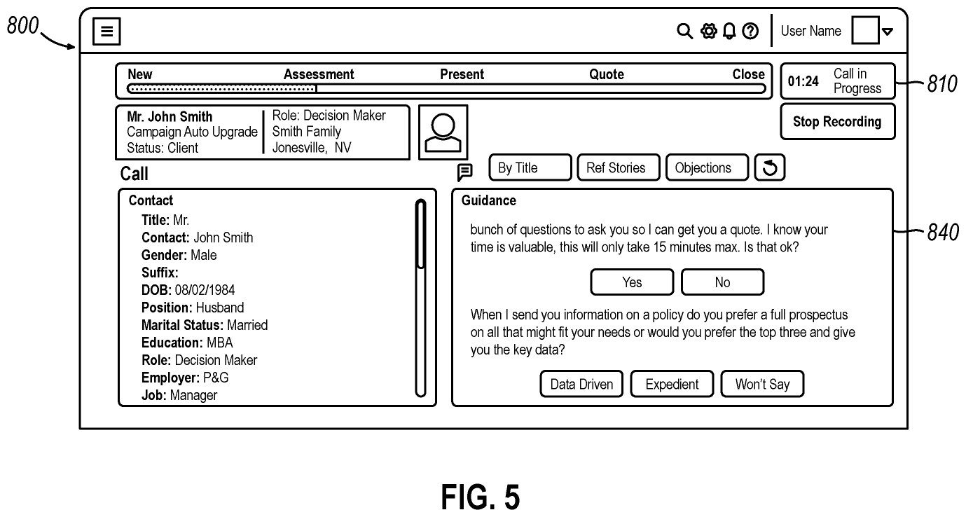

When the salesperson has finished reviewing any needed information from screen 600, they can hit the phone button 670 to call the customer. During a call the salesperson may be presented with screen 800 of FIG. 5. The system can initiate a phone call using an enterprise phone, with an integrated Voice Over IP (VOIP) solution, or via other means. The system is set to record all phone calls, as seen in recording status 810. Guidance 840 may track the call conversation and may provide helpful scripts or prompts for a salesperson to follow during the call. Scripts can include questions to ask a customer. Each prompt or script may include questions for a salesperson to answer regarding the customer's response. The prompts and scripts can be dynamically created in real-time. The system can, over time, have access to hundreds or thousands of previous calls and successful or unsuccessful scripts, prompts and conversations. The system can follow in real-time the conversation and provide prompts or scripts that have the best track record of leading to successful sales outcomes. There may also be scripts or question lists that a salesperson or a manager should answer related to sales targets. This can be a series of questions that allows the system to score a company or buyer, and diagnose (via preset rules or ML-improved algorithms and metrics) the needs the described embodiments can solve. The received answers can increase the system's abilities to measure, predict, and inform. Questions about a sales target may preferably be consistent in structure and content across all campaigns, which allows a deeper understanding.

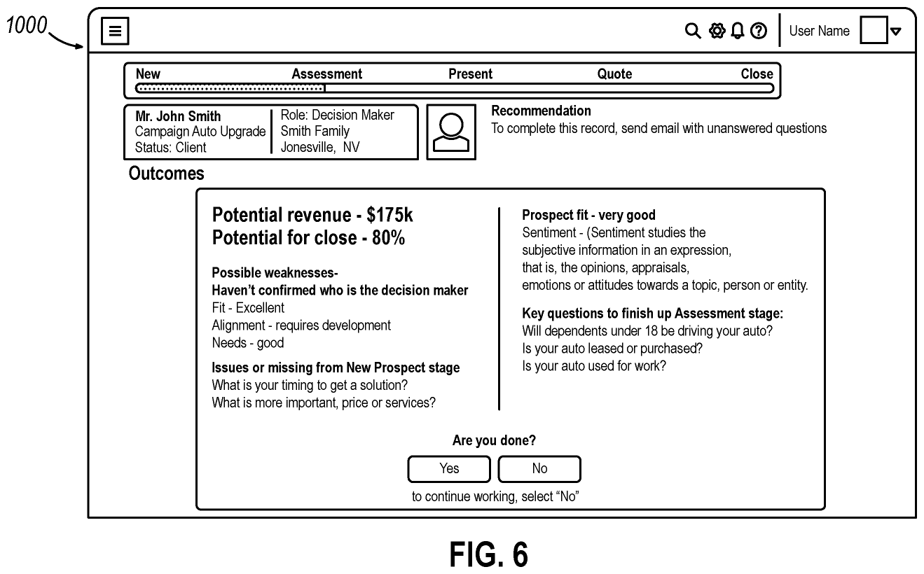

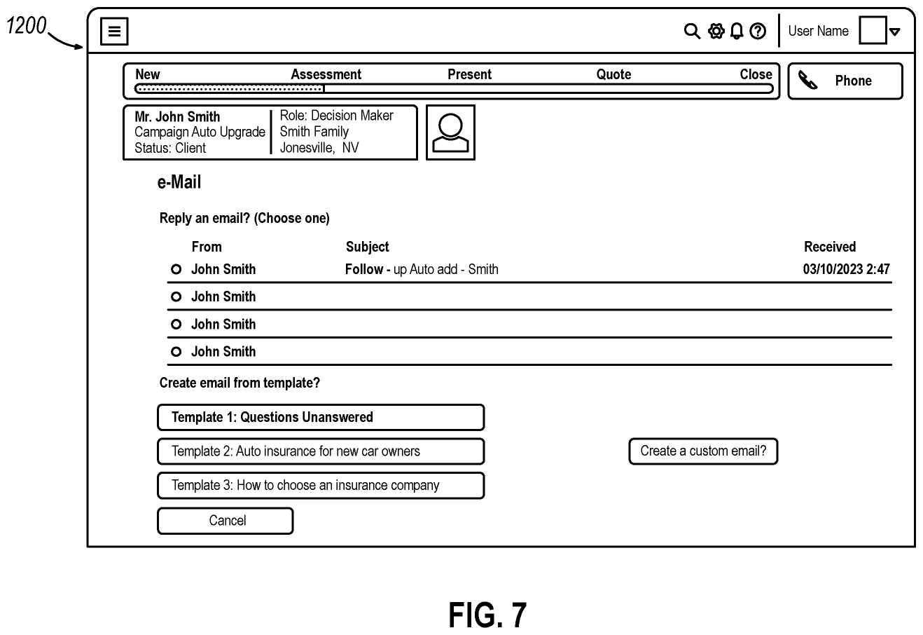

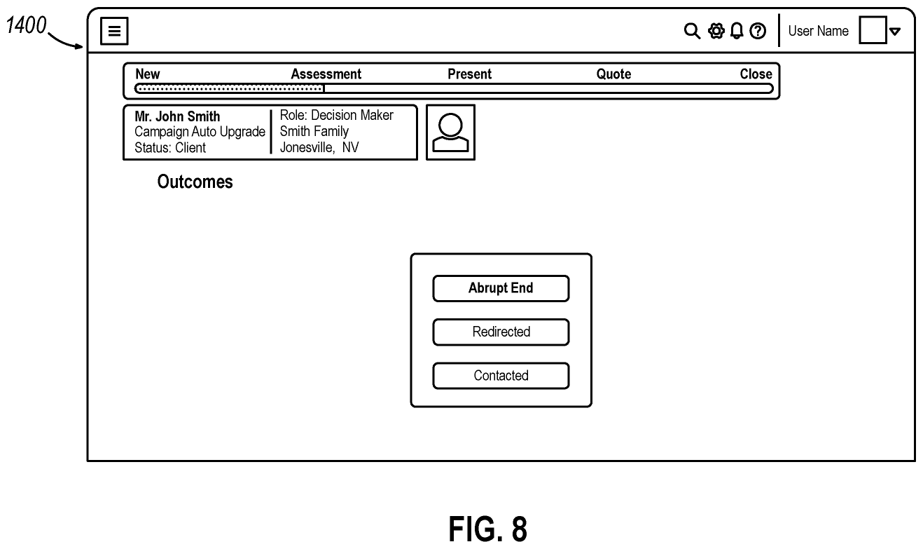

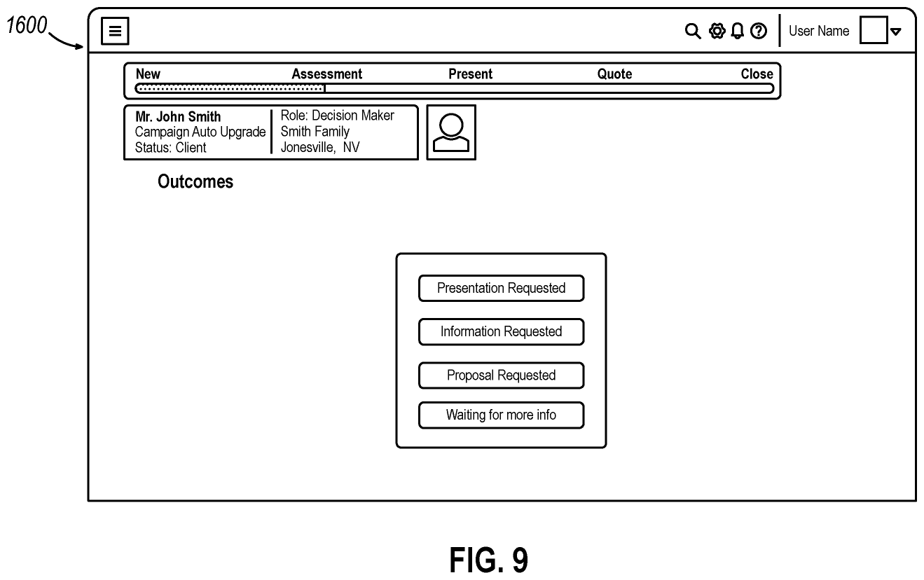

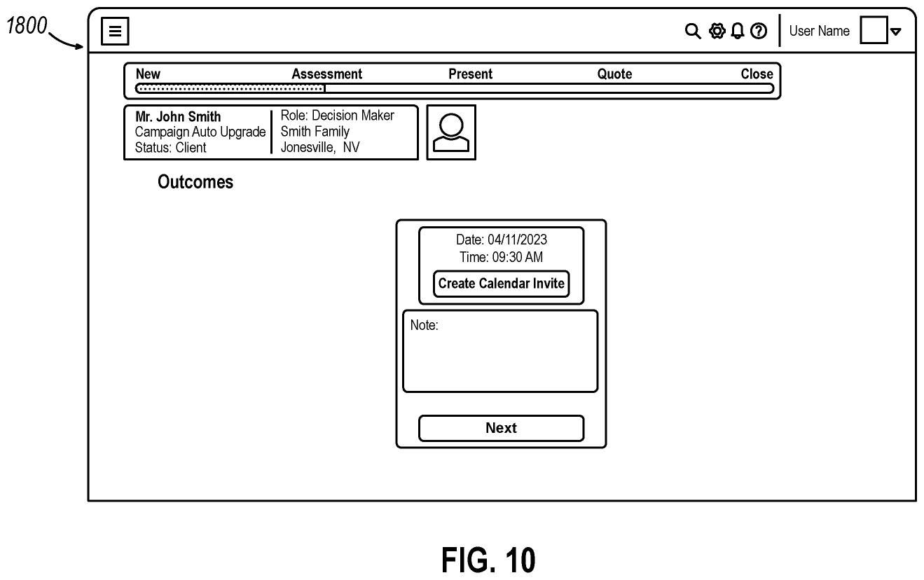

After each call, the system will walk the salesperson through a series of questions, such as in FIGS. 6-10. In preferred embodiments, the salesperson must answer each question in order to move onto the next customer in a task list. FIG. 6 illustrates a possible summary screen 1000 which can allow the salesperson to enter free form text describing the call, the customer, or other factors. FIG. 7 shows a possible email template screen 1200, which can allow the salesperson to immediately choose an email template to send to the customer as a follow-up to the phone call. FIG. 8 shows an example outcome screen 1400 which asks the salesperson to indicate how the call ended. FIG. 9 shows another example outcome screen 1600 which allows the salesperson to indicate several different types of follow up to pursue in relation to the customer. FIG. 10 shows a possible calendar invite template 1800 to create, for example, a calendar invite for a follow up call. While FIGS. 6-10 display possible post-call steps or questions, certain embodiments can comprise further steps or questions. In preferred embodiments the outcomes/question presented to the salesperson are “smart.” This means only the appropriate outcomes are presented to the salesperson based on the data the system automatically collected during their work on the prospect record. And preferably they also can move the prospect forward in the sales process only if the salesperson gathers enough information and the answers match the requirements. This is helpful in determining the potential of a prospect buying, when they are buying, and how they fit in the forecast reports. Current and prior art CRMs use a technique called ‘cadence,’ which is a predetermined contact cycle that is not integrated with the software, is static, and once a prospect interacts in any way, the cadence ends. Embodiments under the present disclosure utilize AI and business rules (combined with intricate data records, like sales call recordings) that are dynamically evolved in response to prospect behavior. Each outcome in the list of outcomes have intelligence behind them and at minimum drives the next contact date and could trigger a significant work flow that the system would manage.

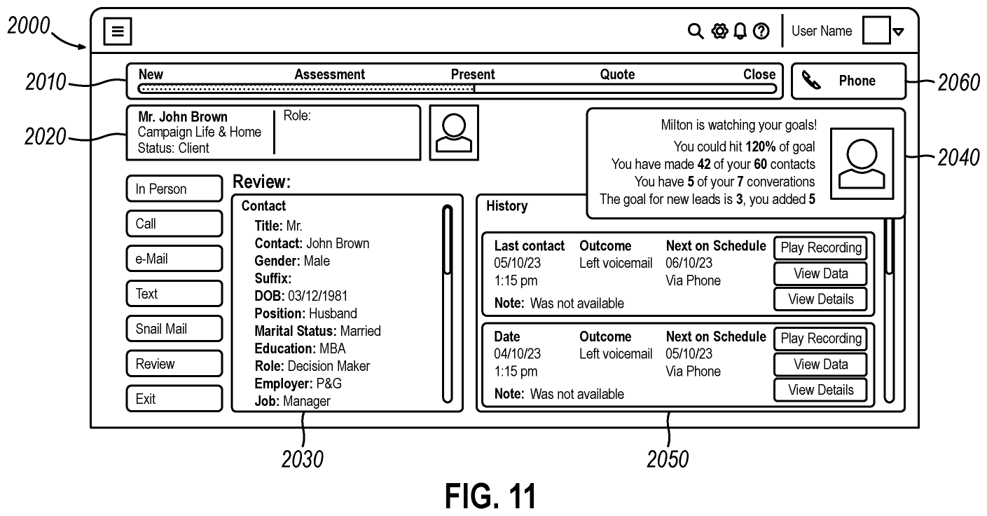

Once the salesperson completes the post-call steps, task list 210 proceeds to the next customer, as shown in FIG. 11. Screen 2000, like screen 600 of FIG. 4, can show e.g., a goal progress indicator 2010, information bar 2020, virtual assistant 2040, contact card 2030, and contact history 2050. Once the salesperson is ready they can press the phone button 2060 and call this next customer. Prompts and scripts provided for this customer can be tailored according to the defining features of this customer and the given sales campaign they are a part of.

One important aspect of certain embodiments is that a salesperson is required to complete these post-call steps. In order to have the best task list 210, with the statistically best chance of higher sales numbers, the system (e.g., system 10 of FIG. 1) preferably has the most complete data possible. This can require, in certain embodiments, recording all phone calls, tracking all emails or other communications, having standardized questions across all customers that salespeople fill out for every customer, and/or using ML or other AI techniques to analyze the collected data, phone calls, and communications, and thereby extract data patterns that can lead to more successful sales campaigns and also ensure accountability amongst salespeople for making their daily/weekly assigned tasks. Due to the structure and requirements for completing key tasks, the system can effectively score the prospect, the action, the process, the campaign, and the salesperson and create trigger points and notifications telling management to get involved and what they need to do to solve any problem. It could happen that while the salesperson is responding to mandatory questions, a call comes in from a sales target, or the salesperson otherwise has to pause their work on mandatory post-call steps. It such situations the system can automatically save the salesperson's progress on the post-call steps, begin recording the phone call, and even open up the information of the interrupting sales target and provide prompts or scripts as needed. The system, in all phone conversations or emails and other communications, can track language in real-time and monitor the progress of calls, and suggest prompts that can help lead to sales. When the interrupting call is over, the system can return the salesperson to the previously pending post-call steps.

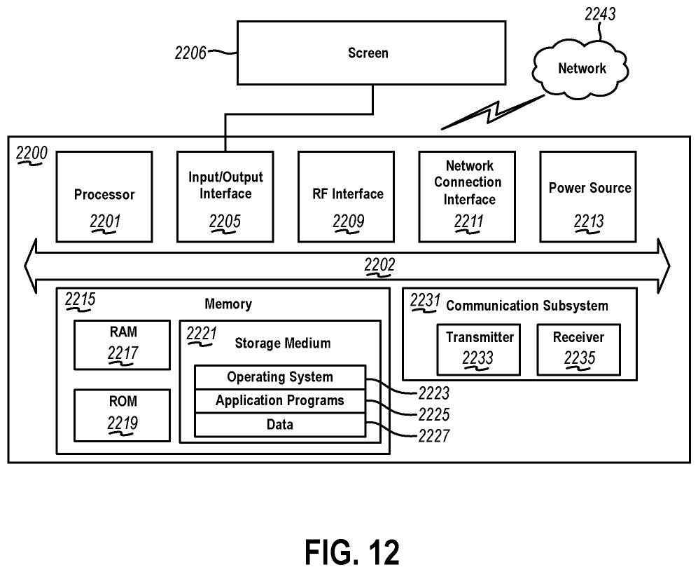

FIG. 12 illustrates an embodiment of a CRM system 2200, such as system 10 of FIG. 1, or components thereof, such as mobile device 35, computer 15, backend server(s) 70, customer lists 45, task lists 50, databases 55, and AI/ML engine 60, configured to implement or perform aspects of the present disclosure. FIG. 12 shows a schematic block diagram of a system 2200 (or components thereof) according to certain embodiments of the present disclosure. Examples of what system 2200 can be used to analyze and/or optimize include: sales call/email/text/communication timing (e.g., days between calls); salesperson capability (e.g., number of calls/day); possible scripts or prompts for use during sales calls; best weather for sales calls; best time of day for sales calls; best day of week for sales calls; language used by customers; likeliness of sales success; and/or any other data which can impact optimization of sales techniques.

System 2200 includes processor 2201 that is operatively coupled via a bus 2202 to an input/output interface 2205, a power source 2213, a memory 2215, an RF interface 2209, network communication interface 2211, and/or any other component, or any combination thereof. Certain systems 2200 may utilize all or a subset of the components shown in FIG. 12. The level of integration between the components may vary from one embodiment to another. Further, certain systems 2200 may contain multiple instances of a component, such as multiple processors, memories, transceivers, transmitters, receivers, etc.

The processor 2201 is configured to process instructions and data and may be configured to implement any sequential state machine operative to execute instructions stored as machine-readable computer programs in memory 2215. Processor 2201 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processor 2201 may include multiple central processing units (CPUs).

In the example, input/output interface 2205 may be configured to provide an interface or interfaces to an input device, output device, or one or more input and/or output devices, such as screen 2206. Examples of an output device include a speaker, a sound card, a video card, a display, a monitor, a printer, an actuator, an emitter, a smartcard, another output device, or any combination thereof. An input device may allow a user to capture information into system 2200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 2213 is structured as a battery or battery pack. Other types of power sources, such as an external power source (e.g., an electricity outlet), photovoltaic device, or power cell, may be used. The power source 2213 may further include power circuitry for delivering power from the power source 2213 itself, and/or an external power source, to the various parts of system 2200 via input circuitry or an interface such as an electrical power cable.

Memory 2215 may be configured to include memory such as random access memory (RAM) 2217, read-only memory (ROM) 2219, programmable read-only memory (PROM), erasable (EPROM), electrically erasable programmable read-only memory (EEPROM), magnetic disks, optical disks, hard disks, removable cartridges, flash drives, other storage medium 2221, and so forth. In one example, the memory 2215 includes one or more application programs 2225, an operating system 2223, web browser application, a widget, gadget engine, or other application, and corresponding data 2227. Memory 2215 may store, for use by the system 2200, any of a variety of various operating systems or combinations of operating systems. An article of manufacture, such as one including a simulation system or communication system may be tangibly embodied as or in memory 2215, which may be or comprise a device-readable storage medium.

Processor 2201 may be configured to communicate with an access network 2243 or other network using the RF interface 2209 or network connection interface 2211. The RF interface 2209 or network connection interface 2211 may comprise one or more communication subsystems, such as communication subsystem 2231 which may further be comprised of a transmitter 2233 and a receiver 2235, and may include or be communicatively coupled to an antenna. In the illustrated embodiment, communication functions of the RF interface 2209 or network connection interface 2211 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof.

System 2200 can perform methods such as described further below, for optimizing or choosing sales techniques, sales timing, or other methods as described herein. Certain embodiments of the present disclosure include machine learning processes for selecting sales approaches. In certain embodiments system 2200 can comprise a AI/ML engine for training or implementing a AI/ML model. The architecture of an ML model (e.g., structure, number of layers, nodes per layer, activation function etc.) may need to be tailored for each particular use case. For example, properties to vary can include, for example, sales call/email/text/communication timing (e.g., days between calls), salesperson capability (e.g., number of calls/day), scripts or prompts for use during sales calls, local weather for sales call recipients, local weather of salespeople, time of day for sales calls, day of week for sales calls, language used by customers, sales success, and/or other data which can impact optimization of sales techniques. These may all need to be considered when designing the ML model's architecture.

Building an AI/ML model includes several development steps where the actual training of the ML model is just one step in a training pipeline. An important part in AI/ML development is the AI/ML model lifecycle management. One embodiment of a model lifecycle management procedure 2300 is illustrated in FIG. 12. The model lifecycle management comprises two pipelines: a training pipeline 2305 and an inference pipeline 2350.

At 2310 in the training pipeline 2305, data ingestion 2310 occurs, which includes gathering raw (training) data from a data storage. After data ingestion 2310, there may also be a step that controls the validity of the gathered data. At 2315 data pre-processing occurs, which can include feature engineering applied to the gathered data. This may involve, for example, data normalization or data formatting or transformation required for the input data to the AI/ML model. After the AI/ML model's architecture is fixed, it should be trained on one or more datasets. At 2320 model training is performed in which the AI/ML model is trained with the raw training data. To achieve good performance during live operation in a system (the so-called inference phase), the training datasets should be representative of actual data the AI/ML model will encounter during live operation. The training process often involves numerically tuning the AI/ML model's trainable parameters (e.g., the weights and biases of the underlying neural network (NN)) to minimize a loss function on the training datasets. The loss function may be, for example, based on a maximum possible sale. The purpose of the loss function is to meaningfully quantify the reconstruction error for the particular use case at hand. At 2325 model evaluation can be performed where the performance is benchmarked to some baseline. Model training 2320 and evaluation 2325 can be iterated until an acceptable level of performance is achieved. At 2330 model registration occurs, in which the AI/ML model is registered with any corresponding data on how the AI/ML model was developed and, for example, AI/ML model evaluation data. At 2335 model deployment occurs, wherein the trained/re-trained AI/ML model is implemented in the inference pipeline 2350.

Data ingestion 2355 in the inference pipeline 2350 refers to gathering raw (inference) data from a data source. Data pre-processing 2360 can be essentially identical/similar to the data pre-processing 2315 of the training pipeline 2305. At 2365, the operational model received from the training pipeline 2305 is used to process new data received during operation of, for example, system 2200 of FIG. 12 or 10 of FIG. 1. At 2370 data and model monitoring is performed. Here the inference data is analyzed to determine whether the inference data are from a distribution that aligns with the training data, as well as monitoring model outputs for detecting any performance, or operational, variance or drifts. The variance or drift is used at 2345 (drift detection) to update the AI/ML model registration.

The training process is typically based on some variant of a gradient descent algorithm, which, at its core, comprises three components: a feedforward step, a back propagation step, and a parameter optimization step. These steps can be described using a dense AI/ML model (e.g., a dense NN with a bottleneck layer) as an example.

Feedforward: A batch of training data, such as a mini-batch (e.g., several downlink-channel estimates), is pushed through the AI/ML model, from the input to the output. The loss function is used to compute the reconstruction loss for all training samples in the batch. The reconstruction loss may be an average reconstruction loss for all training samples in the batch.

The feedforward calculations of a dense AI/ML model with N layers (n=1, 2, . . . , N) may be written as follows: The output vector a^{[n]} of layer n is computed from the output of the previous layer a^{[n-1]} using the equations:

$${z}^{[ n ]} = {W}^{[ n ]} \cdot {a}^{[ n - 1 ]} + {b}^{[ n ]} , {a}^{[ n ]} = g ( {z}^{[ n ]} ) \qquad ( 1 )$$

In the above equation, W^{[n]} and b^{[n]} are the trainable weights and biases of layer n, respectively, and g is an activation function applied elementwise (e.g., a rectified linear unit).

Back propagation (BP): The gradients (partial derivatives of the loss function, L, with respect to each trainable parameter in the AI/ML model) are computed. The back propagation algorithm sequentially works backwards from the AI/ML model output, layer-by-layer, back through the AI/ML model to the input. The back propagation algorithm is built around the chain rule for differentiation: When computing the gradients for layer n in the AI/ML model, it uses the gradients for layer n+1.

For a dense AI/ML model with N layers the back propagation calculations for layer n may be expressed with the following well-known equations:

$$\frac{\partial L}{\partial {a}^{[ n ]}} = {[ {W}^{[ n + 1 ]} ]}^{T} \cdot \frac{\partial L}{\partial {z}^{[ n + 1 ]}} \qquad ( 2 )$$

$$\frac{\partial L}{\partial {z}^{[ n ]}} = \frac{\partial L}{\partial {a}^{[ n ]}} * {g}^{{[ n ]}^{′}} ( {z}^{[ n ]} ) \qquad ( 3 )$$

$$\frac{\partial L}{\partial {W}^{[ n ]}} = \frac{\partial L}{\partial {z}^{[ n ]}} \cdot {[ {a}^{[ n - 1 ]} ]}^{T} \qquad ( 4 )$$

$$\frac{\partial L}{\partial {b}^{[ n ]}} = \frac{\partial L}{\partial {z}^{[ n ]}} \qquad ( 5 )$$

where * here denotes the Hadamard multiplication of two vectors.

Parameter optimization: The gradients computed in the back propagation step are used to update the AI/ML model's trainable parameters. An approach is to use the gradient descent method with a learning rate hyperparameter (α) that scales the gradients of the weights and biases, as illustrated by the following update equations:

$${W}^{[ n ]} = {W}^{[ n ]} - α \cdot \frac{\partial L}{\partial {W}^{[ n ]}} \qquad ( 6 )$$

$${b}^{[ n ]} = {b}^{[ n ]} - α \cdot \frac{\partial L}{\partial {b}^{[ n ]}} \qquad ( 7 )$$

It is preferred to make small adjustments to each parameter with the aim of reducing the average loss over the (mini) batch. It is common to use special optimizers to update the AI/ML model's trainable parameters using gradient information. The following optimizers are widely used to reduce training time and improving overall performance: adaptive sub-gradient methods (AdaGrad), RMSProp, and adaptive moment estimation (ADAM).

The above process (feedforward, back propagation, parameter optimization) is repeated many times until an acceptable level of performance is achieved on the training dataset. An acceptable level of performance may refer to the AI/ML model achieving a pre-defined average reconstruction error over the training dataset (e.g., normalized MSE of the reconstruction error over the training dataset is less than, say, 0.1). Alternatively, it may refer to the AI/ML model achieving a pre-defined value chosen by a user.

In some implementations, a function F(·) may be generated by a AI/ML process, such as, for example, supervised learning, reinforcement learning, and/or unsupervised learning. It should further be understood that supervised learning may be done in various ways, such as, for example, using random forests, support vector machines, neural networks, and the like. By way of non-limiting example, any of the following types of neural networks that may be utilized, including, deep neural networks (DNNs), convolutional neural networks (CNNs), and recurrent neural networks (RNNs), or any other known or future neural network that satisfies the needs of the system. In an implementation using supervised learning the neural networks may be easily integrated into the hardware described in system 2200 of FIG. 12 (e.g., in the form of simple vector-matrix multiplications).

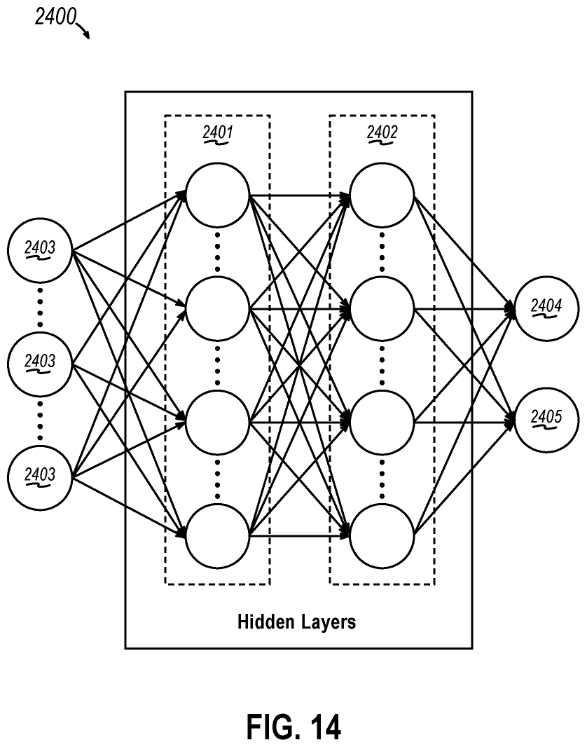

Referring now to FIG. 14, an example neural network (NN) 2400 (e.g., DNN) is shown. In some implementations, and as shown, the neural network 2400 may include two hidden layers represented by dashed boxes 2401 and 2402. In one implementation, the inputs 2403 may be fed into the neural network 2400. Next, the inputs 2403 may go through a set of hidden layers (e.g., 2401 and/or 2402). Once the inputs 2403 pass though the hidden layers 2401 and/or 2402, they may be output (e.g., as an output layer) as for example, the likelihoods of a completed sale 2404; size of sale/purchase 2405; or another output valuable for sales analysis. Possible inputs can include, for example, sales call/email/text/communication timing (e.g., days between calls); salesperson capability (e.g., number of calls/day); scripts or prompts for use during sales calls; best weather for sales calls; best time of day for sales calls; best day of week for sales calls; language used by customers; or a myriad of other tracked data.

As should be understood by one of ordinary skill in the art, in order for the NN 2400 to output a proper analysis, it should be trained properly (e.g., with a collection of samples) to accurately extract the likelihood values. If not trained properly, overfitting (e.g., when the NN memorizes the structure of the preambles but is unable to generalize to unseen preamble characteristics) or underfitting (e.g., when the NN is unable to learn a proper function even on the data that it was trained on) may happen. Thus, implementations may exist that prevent overfitting or underfitting, involving a set of well-engineered features that must be extracted from the preamble characteristics.

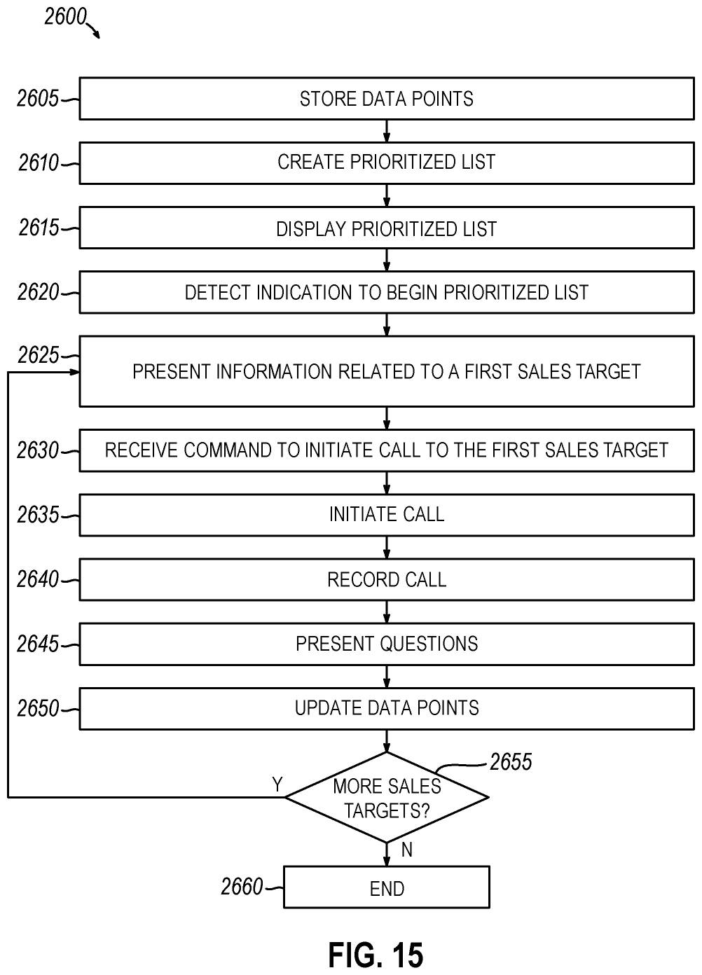

A possible embodiment of a method under the present disclosure is shown in FIG. 15. Method 2600 comprises a method performed by a CRM system for prioritizing one or more sales targets. Step 2605 is storing one or more data points related to one or more sales targets, the one or more data points including one or more communications between a salesperson and the one or more sales targets. Step 2610 is creating a prioritized list of the one or more sales targets, the prioritized list comprising an optimized order of the one or more sales targets to maximize one or more sales campaigns, wherein the prioritized list is based at least in part on the one or more data points. Step 2615 is displaying the prioritized list to a salesperson. Step 2620 is detecting an indication from the salesperson to begin the prioritized list. Step 2625 is presenting to the salesperson information related to a first of the one or more sales targets on the prioritized list including an option to call the first of the one or more sales targets. Step 2630 is receiving a command to initiate a call to the first of the one or more sales targets. Step 2635 is initiating the call. Step 2640 is recording the call. Step 2645 is presenting one or more mandatory questions to the salesperson after the call. Step 2650 is updating the one or more data points with the recording of the call and one or more answers to the one or more mandatory questions. Step 2655 is determining if there are more sales targets in the prioritized list. If No, then the process ends at step 2660. If yes, then the method repeats steps 2625 to 2655 for subsequent of the one or more sales targets in the prioritized list. Method 2600 can comprise a variety of alternative or additional steps. The ordering of the steps may also vary. For example, data points may be updated in parallel as the one or more mandatory questions are answered.

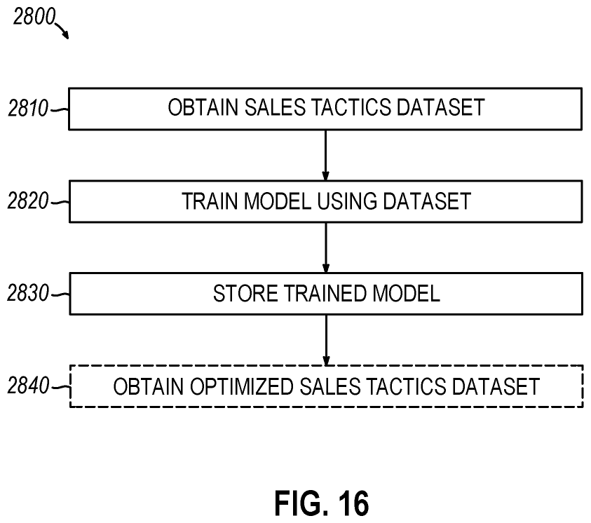

Another possible embodiment of a method under the present disclosure is shown in FIG. 16. Method 2800 is a computer implemented method for training a machine learning model for optimizing one or more sales outcomes. Step 2810 is obtaining a dataset of identified sales tactics. Step 2820 is training the AI/ML model using the dataset of identified sales tactics thereby obtaining a trained ML model. Step 2830 is storing the trained ML model. Method 2800 can comprise a variety of additional or alternative steps. For example, it can further comprise inference steps, such as optional step 2840. Step 2840 is obtaining a dataset of optimized sales tactics by the trained model by inputting a dataset of sales tactics into the trained model, wherein the dataset of sales tactics comprises one or more recordings of one or more sales calls between one or more salespeople and one or more sales targets, one or more answered questions required of the one or more salespeople after each of the one or more sales calls, and one or more sales outcomes related to the one or more sales targets.

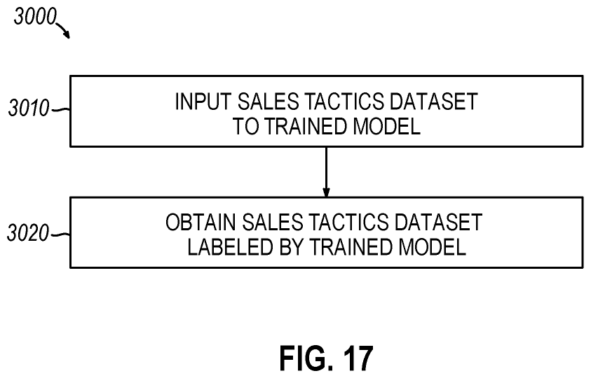

Another possible embodiment of a method under the present disclosure is shown in FIG. 17. Method 3000 is a computer implemented method for obtaining optimized sales tactics. Step 3010 is inputting a dataset of sales tactics into a trained model, the model being trained using one or more recordings of one or more sales calls between one or more salespeople and one or more sales targets, one or more answered questions required of the one or more salespeople after each of the one or more sales calls, and one or more sales outcomes related to the one or more sales targets. Step 3020 is obtaining a dataset of sales tactics labeled by the trained model. Method 3000 can comprise multiple alternative embodiments with additional or alternative steps.

Further embodiments of the present disclosure can provide templates, such as for an employer to create a sales campaign. The employer can identify a product or service to be sold, a list of sales targets, and/or a sales goal. The system can automatically analyze the list of sales targets, analyze sales target personalities, analyze salesperson personalities, and other factors, and create a campaign task list for each of a plurality of salespeople. The campaign task list can be broken up into daily task lists once the salespeople begin working on it. The employer can be provided with a campaign dashboard by which to monitor all salespeople and their progress on the given campaign. The system may provide estimates of, for example, how many phone calls will be needed to reach $1 million in sales, or how many more sales targets are needed to achieve $10 million in sales, or other types of estimates. As the campaign progresses, a machine learning model (as described above) may dynamically reassign salespeople to sales targets based on personality profiles, adjust scripts and prompts based on sales successes in the campaign, or make other adjustments based updated data collected during the campaign.

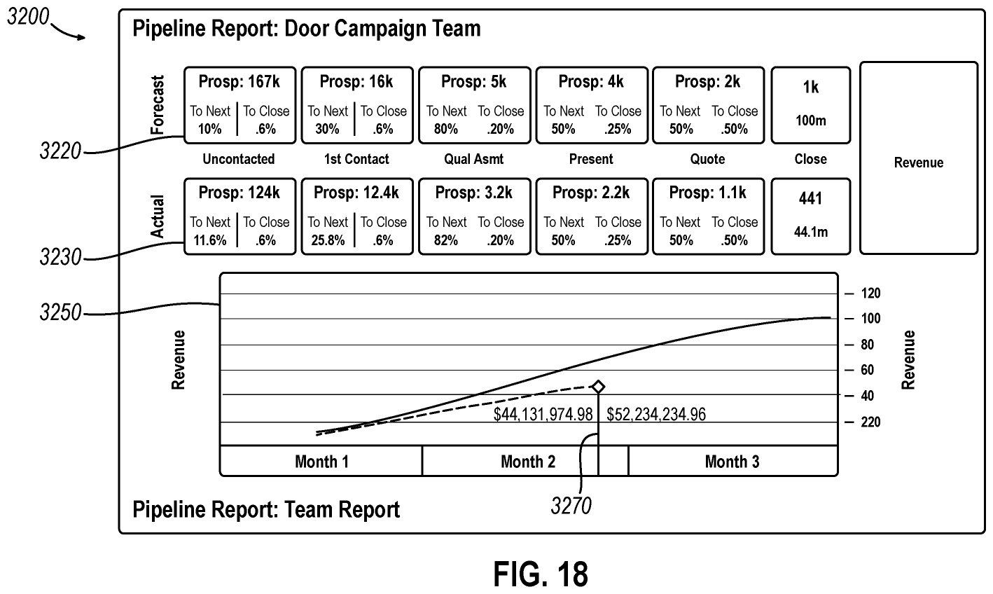

FIG. 18 displays an example campaign user interface (UI) 3200. UI 3200 can comprise a forecast row 3220, actual data row 3230, and revenue graph 3250. Forecast row 3220 at the top of the report has taken data from past campaigns with similar characteristics (e.g., types of prospects, each sales rep assigned, how many prospects, quality, contact title, available data, last contact cycle outcome, etc.), potential revenue of segment identified, time available, competitive environment, psychographic data on salespeople and prospects, and other possible data, combined with conversion rates for each stage in the sales process, numbers of prospects needed for each salesperson. Forecast row 3220 can give projected data about, for example, Prospects (Prosp:) estimates for each stage, conversion rates, and expected results. Actual data row 3230 can display actual real time data from a sales campaign. The system can display data for each stage, on any given date for the life of the campaign, for any given salesperson. A forecasted ‘ideal prospect’ can be compared to any actual salesperson to judge or create a profile of the types that are moving forward or dropping out. Revenue graph 3250 can show actual data over time, or the system can show actual data in real time and create an overlay of where a campaign is right now compared to what was forecasted and where the campaign “should” be to hit our final forecast numbers. Slider 3270 can slide forward and backward to select a date. The graph can show the trend based on current trajectory all the way to campaign completion.

UI 3200 can be used to fix low performance. It can show where and who is failing to meet their part of the campaign down to the exact point in the sales process where they struggle, and suggest remedies. They can see if the salesperson, database, message, or process is the problem and how to fix each. With the projection it can show how big the problem is and get out in front of the solution.

Although the computing devices described herein (e.g., computers or smart devices) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

It will be appreciated that computer systems are increasingly taking a wide variety of forms. In this description and in the claims, the terms “controller,” “computer system,” or “computing system” are defined broadly as including any device or system—or combination thereof—that includes at least one physical and tangible processor and a physical and tangible memory capable of having thereon computer-executable instructions that may be executed by a processor. By way of example, not limitation, the term “computer system” or “computing system,” as used herein is intended to include personal computers, desktop computers, laptop computers, tablets, hand-held devices (e.g., mobile telephones, PDAs, pagers), microprocessor-based or programmable consumer electronics, minicomputers, mainframe computers, multi-processor systems, network PCs, distributed computing systems, datacenters, message processors, routers, switches, and even devices that conventionally have not been considered a computing system, such as wearables (e.g., glasses).

The computing system also has thereon multiple structures often referred to as an “executable component.” For instance, the memory of a computing system can include an executable component. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed by one or more processors on the computing system, whether such an executable component exists in the heap of a computing system, or whether the executable component exists on computer-readable storage media. The structure of the executable component exists on a computer-readable medium in such a form that it is operable, when executed by one or more processors of the computing system, to cause the computing system to perform one or more functions, such as the functions and methods described herein. Such a structure may be computer-readable directly by a processor—as is the case if the executable component were binary. Alternatively, the structure may be structured to be interpretable and/or compiled—whether in a single stage or in multiple stages-so as to generate such binary that is directly interpretable by a processor.

The terms “component,” “service,” “engine,” “module,” “control,” “generator,” or the like may also be used in this description. As used in this description and in this case, these terms—whether expressed with or without a modifying clause—are also intended to be synonymous with the term “executable component” and thus also have a structure that is well understood by those of ordinary skill in the art of computing.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

In general, the various exemplary embodiments may be implemented in hardware or special purpose chips, circuits, software, logic, or any combination thereof. For example, some aspects may be implemented in hardware, while other aspects may be implemented in firmware or software which may be executed by a controller, microprocessor, or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques, or methods described herein may be implemented in, as non-limiting examples, hardware, software, firmware, special purpose circuits or logic, general purpose hardware or controller or other computing devices, or some combination thereof.

While not all computing systems require a user interface, in some embodiments a computing system includes a user interface for use in communicating information from/to a user. The user interface may include output mechanisms as well as input mechanisms. The principles described herein are not limited to the precise output mechanisms or input mechanisms as such will depend on the nature of the device. However, output mechanisms might include, for instance, speakers, displays, tactile output, projections, holograms, and so forth. Examples of input mechanisms might include, for instance, microphones, touchscreens, projections, holograms, cameras, keyboards, stylus, mouse, or other pointer input, sensors of any type, and so forth.

### Abbreviations and Defined Terms

To assist in understanding the scope and content of this written description and the appended claims, a select few terms are defined directly below. Unless defined otherwise, all technical and scientific terms used herein have the same meaning as commonly understood by one of ordinary skill in the art to which the present disclosure pertains.

The terms “approximately,” “about,” and “substantially,” as used herein, represent an amount or condition close to the specific stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a specifically stated amount or condition.

The terms “AI/ML,” “AI,” and “MI” may be used interchangeably and are not to be construed as self-limiting unless otherwise stated in the present description.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or embodiments includes a specific reference to one or more embodiments thereof, and vice versa, and is intended to provide illustrative examples without limiting the scope of the present disclosure, which is indicated by the appended claims rather than by the present description.

As used in the specification, a word appearing in the singular encompasses its plural counterpart, and a word appearing in the plural encompasses its singular counterpart, unless implicitly or explicitly understood or stated otherwise. Thus, it will be noted that, as used in this specification and the appended claims, the singular forms “a,” “an” and “the” include plural referents unless the context clearly dictates otherwise. For example, reference to a singular referent (e.g., “a widget”) includes one, two, or more referents unless implicitly or explicitly understood or stated otherwise. Similarly, reference to a plurality of referents should be interpreted as comprising a single referent and/or a plurality of referents unless the content and/or context clearly dictate otherwise. For example, reference to referents in the plural form (e.g., “widgets”) does not necessarily require a plurality of such referents. Instead, it will be appreciated that independent of the inferred number of referents, one or more referents are contemplated herein unless stated otherwise.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### CONCLUSION

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

It is understood that for any given component or embodiment described herein, any of the possible candidates or alternatives listed for that component may generally be used individually or in combination with one another, unless implicitly or explicitly understood or stated otherwise. Additionally, it will be understood that any list of such candidates or alternatives is merely illustrative, not limiting, unless implicitly or explicitly understood or stated otherwise.

In addition, unless otherwise indicated, numbers expressing quantities, constituents, distances, or other measurements used in the specification and claims are to be understood as being modified by the term “about,” as that term is defined herein. Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical values, however, inherently contain certain errors necessarily resulting from the standard deviation found in their respective testing measurements.

Any headings and subheadings used herein are for organizational purposes only and are not meant to be used to limit the scope of the description or the claims. The terms and expressions which have been employed herein are used as terms of description and not of limitation, and there is no intention in the use of such terms and expressions of excluding any equivalents of the features shown and described or portions thereof, but it is recognized that various modifications are possible within the scope of the present disclosure. Thus, it should be understood that although the present disclosure has been specifically disclosed in part by certain embodiments, and optional features, modification and variation of the concepts herein disclosed may be resorted to by those skilled in the art, and such modifications and variations are considered to be within the scope of this present description.

It will also be appreciated that systems, devices, products, kits, methods, and/or processes, according to certain embodiments of the present disclosure may include, incorporate, or otherwise comprise properties or features (e.g., components, members, elements, parts, and/or portions) described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein.

It will be apparent to one of ordinary skill in the art that methods, devices, device elements, materials, procedures, and techniques other than those specifically described herein can be applied to the practice of the described embodiments as broadly disclosed herein without resort to undue experimentation. All art-known functional equivalents of methods, devices, device elements, materials, procedures, and techniques specifically described herein are intended to be encompassed by this present disclosure.

When a group of materials, compositions, components, or compounds is disclosed herein, it is understood that all individual members of those groups and all subgroups thereof are disclosed separately. When a Markush group or other grouping is used herein, all individual members of the group and all combinations and sub-combinations possible of the group are intended to be individually included in the disclosure.

The above-described embodiments are examples only. Alterations, modifications, and variations may be effected to the particular embodiments by those of skill in the art without departing from the scope of the description, which is defined solely by the appended claims.

1. A system for customer relationship management (CRM), the system comprising:
a conversation recorder configured to record one or more conversations between a salesperson and one or more sales targets;
a user interface coupled to the conversation recorder and configured to receive input from the salesperson; and
one or more servers coupled to the user interface and configured to store one or more data points related to the one or more sales targets, wherein the one or more data points includes the one or more conversations and wherein the one or more servers are further configured to provide the salesperson, via the user interface, a task list for a specific work day, the task list comprising a prioritized list of the one or more sales targets, the prioritized list comprising an optimized order of the one or more sales targets to maximize one or more sales campaigns, wherein the prioritized list is based at least in part on the one or more data points.

2. The system of claim 1, wherein the conversation recorder and the user interface both comprise one of: a computer; a smart device; a tablet; a smartphone.

3. The system of claim 1, wherein the conversation recorder comprises a microphone coupled to a computing device.

4. The system of claim 1, wherein the one or more data points comprise one or more of: real-time weather data at a location of the one or more sales targets; personal net worth of at least one of the one or more sales targets; size of a company represented by the one or more sales targets; time zone of the one or more sales targets; number of days since a previous communication.

5. The system of claim 1, wherein the one or more servers are further configured to use a machine learning model to analyze the one or more data points and to create the prioritized list based at least in part on the analysis.

6. The system of claim 1, wherein the user interface is further configured to receive a command from the salesperson to place a phone call to the one or more sales targets.

7. The system of claim 1, wherein the one or more servers are further configured to access the Internet to find additional data points related to the one or more sales targets.

8. The system of claim 5, wherein the machine learning model utilizes one or more of the following: deep neural network (DNN); convolutional neural network (CNN); and recurrent neural network (RNN).

9. A method performed by a customer relationship management (CRM) system for prioritizing one or more sales targets, the method comprising:
(a) storing one or more data points related to one or more sales targets, the one or more data points comprising one or more communications between a salesperson and the one or more sales targets;
(b) creating a prioritized list of the one or more sales targets, the prioritized list comprising an optimized order of the one or more sales targets to maximize one or more sales campaigns, wherein the prioritized list is based at least in part on the one or more data points;
(c) displaying the prioritized list to a salesperson;
(d) detecting an indication to begin the prioritized list from the salesperson;
(e) presenting to the salesperson information related to a first of the one or more sales targets on the prioritized list, the information comprising an option to call the first of the one or more sales targets;
(f) receiving a command to initiate a call to the first of the one or more sales targets;
(g) initiating the call;
(h) recording the call;
(i) presenting one or more mandatory questions to the salesperson after the call has ended;
(j) preceding to a subsequent one of the one or more sales targets on the prioritized list only when the one or more mandatory questions are completed;
(k) updating the one or more data points with the recording of the call and one or more answers to the one or more mandatory questions; and
(l) repeating steps (f) to (k) for each subsequent one of the one or more sales targets on the prioritized list.

10. The method of claim 9, wherein the one or more data points comprise one or more of: real-time weather data at a location of the one or more sales targets; personal net worth of at least one of the one or more sales targets; size of a company represented by the one or more sales targets; time zone of the one or more sales targets; number of days since a previous communication.

11. The method of claim 9, wherein the creating a prioritized list comprises using a machine learning model to analyze the one or more data points and to create the prioritized list based at least in part on the analysis.

12. The method of claim 9, further comprising accessing the Internet to find additional data points related to the one or more sales targets.

13. The method of claim 9, further comprising analyzing the one or more data points after each call and adjusting the prioritized list based at least in part on the analysis.

14. The method of claim 9, wherein the recording is performed by one or more of: a smart device; a computer; a microphone.

15. The method of claim 9, wherein step (e) comprises presenting via one or more of: a smart device; a computer; a tablet; a smartphone.

16. The method of claim 9, wherein step (g) comprises one or more of: initiating a Voice Over Internet Protocol (VOIP) call; initiating a call via an enterprise phone system.

17. The method of claim 11, further comprising training the machine learning model on a pre-existing data set.

18. The method of claim 11, further comprising optimizing the machine learning model for one or more expected sales outcomes, and updating the machine learning model with the updated one or more data points.

19. A computer implemented method for training a machine learning (ML) model for optimizing one or more sales outcomes comprising:
obtaining a dataset of identified sales tactics;
training the ML model using the dataset of identified sales tactics thereby obtaining a trained ML model; and
storing the trained ML model.

20. The method of claim 19, further comprising obtaining a dataset of optimized sales tactics by the trained model by inputting a dataset of sales tactics into the trained model, wherein the dataset of sales tactics comprises one or more recordings of one or more sales calls between one or more salespeople and one or more sales targets, one or more answered questions required of the one or more salespeople after each of the one or more sales calls, and one or more sales outcomes related to the one or more sales targets.
